(19) United States
(12) Patent Application Publication
(10) Pub. No.: US 2014/0127745 A1
(43) Pub. Date: May 8, 2014

(54) METHOD, COMPOSITIONS AND DEVICE FOR PREPARING CYTOLOGICAL SPECIMENS

(71) Applicants: Roy Mora Gonzaga, San Jose (CR); Robin A. Wiscovitch, Atenas (CR); Juan Valdés González, Heredia (CR)

(72) Inventors: Roy Mora Gonzaga, San Jose (CR); Robin A. Wiscovitch, Atenas (CR); Juan Valdés González, Heredia (CR)

(73) Assignee: BIOTECHNOLOGY DEVELOPERS, S.A., Heredia (CR)

(21) Appl. No.: 14/126,065

(22) PCT Filed: Jun. 22, 2012
(86) PCT No.: PCT/IB2012/001261

§ 371 Date: Dec. 13, 2013

Related U.S. Application Data
(60) Provisional application No. 61/501,088, filed on Jun. 24, 2011.

(51) Int. Cl. G01N 1/30; G01N 1/28

(52) U.S. Cl. CPC G01N 1/30; G01N 1/2813
USPC 435/40.51; 106/170.51; 422/536

(57) ABSTRACT

The invention relates to a method for preparing specimens from tissue samples for cytology microscopic examination, and includes inventive compositions and a device used in said method. The invention also includes a diagnostic kit comprising the inventive compositions and device.

### TECHNICAL FIELD

The present invention relates to the field of clinical analysis and particularly discloses a method for preparing specimens from tissue samples for cytology microscopic examination, and inventive compositions and devices used in said method. The invention also includes a diagnostic kit comprising the inventive compositions and device.

### BACKGROUND

Cytological techniques for diagnosis are widely used since collection of cell samples for analysis is generally less invasive and comfortable than surgical pathological procedures such as biopsies. Once collected, the cell samples are typically placed in preservative compositions and subsequently transferred to a glass slide for viewing under magnification. Fixative and staining compositions may be applied to the cells on the glass slide for preserving the specimen for archival purposes and for facilitating examination.

The quality of the cytological diagnosis depends mainly on the laboratory procedures used to process the samples. In general, the material for cytological examination is obtained either in the form of smears or of fluid specimens, which need to be further processed.

Papanicolaou (pap) smear has been a widely recognized method for screening abnormal tissues, which has allowed preventing many cases of cervical carcinoma. It is a simple and inexpensive method. However the procedure for the collection and preparation of the sample is regarded as primitive, more uncomfortable for the patient, less efficient in terms of the fraction of the sample that is actually screened and more prone to human error.

Liquid-based cytology has been developed to address most of these issues and, thus reduce the number of false-positive and false-negative smear results. Two commercially available systems that apply the liquid-based cytology concept are used widely in the United States and Europe. They are the ThinPrep system (Cytyc, Boxborough, Mass.) and the AutoCytePrep system (currently known as SurePath; TriPath Imaging, Burlington, N.C.). Both systems were developed and tested in the United Sates and obtained approval of the U.S. Food and Drug Administration for primary screening (Klinkhamer, P. J. J. M., et al. Cancer Cytopathology, Oct. 25, 2002, Vol. 99, Num. 5, pages 263-271).

Surepath®, previously known as Autocyte®, CytoRich™, is a method in which a sample from the cervix is collected using a plastic collection device. The head of the collection device is detached into a vial containing a proprietary transport fluid (CytoRich™). In the laboratory the vials are vortex mixed and the cell suspension is treated through a density gradient centrifugation process to remove red blood cells and other clinically non-significant material and to enrich the cell suspension. The centrifuge tubes are loaded onto an AutoCytePrep ‘robot’ which handles 48 samples at a time. The cell pellet is re-suspended and an aliquot is transferred to a settling chamber mounted on a microscope slide. The cells are allowed to sediment under gravity to form a thin layer on the slide. Excess fluid and cells are removed and the slide is then stained automatically as part of the process.

The proprietary transport fluid (CytoRich™) used in Surepath® is disclosed in the U.S. Pat. No. 6,916,608 concerning a composition for providing long term stability to cells for diagnostic testing, based on a mixture of a first substance which is at least one alcohol or ketone and a second facilitating substance such as dimethyl sulfoxide (DMSO).

The other liquid-based cytology mostly used is ThinPrep® (Cytyc Corporation). This was developed in 1996 and is currently available as the ThinPrep® 3000 System. It uses a plastic collection device which is rinsed thoroughly into a vial containing a proprietary transport fluid (PreservCyt®). In the laboratory, each vial is placed individually in the ThinPrep® 3000 Processor. The process is commonly described as proceeding in three phases:
(a) dispersion: to produce a randomized cell suspension breaking up cell clumps and mucus.
(b) cell collection: a negative pressure pulse is produced which draws the fluid through a filter trapping a layer of cellular material. The flow of fluid through the filter is monitored and controlled to optimize cell collection.
(c) cell transfer: the cellular material on the filter is transferred to a glass slide which is then deposited into a vial of fixative. Subsequent staining and microscopic evaluation of the slides proceeds in a similar manner to a conventional smear.

The ThinPrep® 3000 process system is designed to improve productivity further by providing automated batch-processing of up to 80 specimens per cycle.

The proprietary transport fluid (PreservCyt®) is covered by the U.S. Pat. No. 5,256,571, which discloses an alcohol buffer solution comprising water-miscible alcohol, in combination with an anti-clumping agent and a buffering agent. The alcohol is one from the group consisting of ethanol and methanol.

The anti-clumping agent is a chelating agent, preferably one from the group consisting of ethylenediaminetetra-acetic acid (EDTA), and its salts, such as disodium, tripotassium and tetrasodium. The buffering agent is selected from the group consisting of PBS, Tris buffer, sodium acetate, EDTA, ethylenedinamine tetraacetic acid salts, citric acid and citric acid salts.

Both the Surepath® and the Thinprep® methods rely on sophisticated and expensive equipment for processing the samples. This raises the price of the analysis and makes it inaccessible to small laboratories.

CYTOSCREEN® (Altrix Healthcare Plc) is another of the currently used liquid-based cytology system. A proprietary plastic collection device (CYTOPREP®) is used to collect a cervical sample and the head is detached into a vial of proprietary transport fluid (CYTeasy™). In the laboratory the vials are placed on a shaker before a photometric reading is taken to assess cellularity. An appropriate aliquot of the sample is centrifuged onto a glass slide. Staining follows using normal laboratory staining procedures. Samples are said to be “processed with the CYTOSCREEN® method using standard laboratory equipment, readily available in the market and in most labs. The only innovations centre in the composition of the preservative and the method of establishing the volume of sample necessary to produce a fully CYTOPREP® representative sample and an adequate quantity of cells”. (Altrix Healthcare's submission to NICE, October 1999).

LABONORD Easy Prep® (Surgipath Europe Ltd.) is a method in which the samples are taken using a plastic collection device and transferred to proprietary fixative fluid. An aliquot of the fluid is placed in a separation chamber with a strip of absorbent paper punched to produce a 250 mm hole. Eight chambers are placed together in a clamping unit. The plastic chamber retains the cell suspension in place during sedimentation whilst the absorbent paper gently removes the fluid resulting in a dry, thin layer of cells. In this system, the composition of the proprietary fixative fluid is not disclosed in the prior art.

This is a method for producing a liquid-based preparation that is said to have the advantages of the methodology, but does not rely on the use of additional expensive instrumentation and uses standard laboratory equipment. (Surgipath Europe's submission to NICE, January 2000).

On the other hand, the U.S. Pat. No. 5,492,837 provides compositions and methods for permanently mounting tissue sections on microscope slides using an aqueous solution of polyvinylpyrrolidone 3-15% (v/v). The main limitations in this type of composition is the optical quality of the medium but most all the temperature and time that are required in order to solidify the medium.

The idea of using a filtering device for separating the liquid and particulate matter (such as cells) during the processing of a cytological sample is well known. These devices typically involve a pumping method based on a barrel and plunger assembly which is used to produce flow through a filter. There are many possible configurations for this concept. U.S. Pat. No. 3,870,639 reveals one of such devices, in which a test tube is used as a barrel and the filter is integrated to a plunger which is pushed by means of an inner tube. In another configuration, as revealed in U.S. Pat. No. 5,042,502, the filter is enclosed in a chamber with a first port and a second port which define a flow path across said filter. The pumping part of the system, also referred to as shuttle, is a separate device, generally described as a plunger inside a closed barrel or tube with a port, most commonly referred to as a hypodermic syringe or a syringe pump.

U.S. Pat. Nos. 5,301,685 and 5,471,994 reveal a type of such filter chamber assembly which is specifically intended to produce a monolayer of cells on a glass slide. In these patents the device is referred to as a cytology collection apparatus. The filter chamber assembly is connected to an empty syringe pump. The opposite port in the chamber may be connected directly to a special sample container or to a needle. In both cases the sample is pumped through the filter chamber by aspiration from the syringe pump. In this process the intention is for a layer of cells to collect on the surface of the filter.

The main method to apply this layer of cells on a glass slide is to detach one half of the chamber in order to expose the cells and apply them directly from the filter surface onto the slide. Another method is disclosed with the intention of laying it on a culture medium. In this method a certain amount of fluid is pumped back through the filter (an action known as back-flush). This fluid carries a concentrated aliquot of the sample, which is dropped on the culture medium. The method, however, overlooks the potential for placing said aliquot on a glass slide, and is therefore not properly configured for this purpose.

One disadvantage of this approach is that the sample flows into the filter by aspiration. Suction of a fluid through a filter is known to be inefficient, as it must rely on atmospheric pressure, while the resistance to flow through the filter can be relatively high. It is not uncommon for the plunger in a regular syringe pump to come apart during suction, in which case the process fails. This limitation becomes evident as a special filter chamber design is described, in order to bypass the fluid around the filter as it becomes clogged with particulate matter. Such bypass in turn would keep part of the sample from forming a layer on the filter as desired.

Another disadvantage of the method, involving detachment of one half of the chamber, is that this requires a careful manual operation of a relatively small device (unless a relatively expensive automated mechanism is used), and in the meantime the sample is exposed to undesired contact with other surfaces while said operation is performed. Furthermore the design of a chamber made of detachable halves is relatively complex, including the attachment mechanism and the sealing of the chamber. A simpler chamber which does not require disassembly would be advantageous.

Furthermore, the filtration method as revealed doesn't provide a means to apply a fixative or processing solution to the sample. Therefore this must be performed at an additional step, typically once the sample is on the glass slide.

A more subtle limitation of this art is the inability to select the cells on the surface of the filter according to size. Particularly in the case of cervical screening, it would be desirable to favor the deposition of certain cell sizes on the glass slide.

### SUMMARY OF THE INVENTION

The present invention provides inventive methods and products suitable for liquid-based cytology which constitute an alternative for these analyses characterized by being simple, reliable and inexpensive.

The inventive method for preparing a specimen from a tissue sample for cytology microscopic examination has been created together with several compositions and a device for expedite processing and produces high quality results in the cytological analysis of the samples.

The method of the present invention comprises the following main steps:
(a) collecting a tissue sample from a subject using an appropriate collector device with a detachable portion;
(b) preserving said sample in a liquid suspension by placing said detachable collector device portion inside a vial containing a cell preservative composition;
(c) processing said sample with a fixative composition in order to fix it on a hot glass slide, using a method selected from the group consisting of processing in a test tube and processing in a filter chamber assembly;
(d) allowing the processed sample to dry on the glass slide until the cytological material is adhered to said glass slide;
(e) adding a staining solution to the dried sample on the glass slide;
(f) waiting for the drying of the stained sample;
(g) adding a transparent thermoplastic polymer-based solidifying mounting medium to the sample; and
(h) allowing the specimen to dry on the slide to be ready for microscopic examination.

In a preferred embodiment, the step of processing the sample in a test tube comprises the following sub-steps:
(c.i) transferring the sample suspended in the preservative liquid from the vial to a test tube;
(c.ii) concentrating the sample by centrifugation;
(c.iii) decanting the supernatant fluid;
(c.iv) adding a fixative composition;
(c.v) shaking the test tube to achieve homogenization of the cellular material;
(c.vi) adding water and shaking again the test tube for homogenization;
(c.vii) extracting an aliquot from the homogenized sample; and
(c.viii) placing the extracted aliquot on a hot glass slide.

In an alternative embodiment, the step of processing the sample in a filter chamber assembly comprises the following sub-steps:
(c.i) loading the sample in the preservative composition into a first syringe pump
(c.ii) discharging the sample through a filter chamber assembly whose first port is connected to said first syringe pump, the solid part of the sample being thereby retained in said filter, while the fluid part passes through said filter and is discarded through a second port from said filter chamber assembly;
(c.iii) detaching said filter chamber assembly from said first syringe and connecting said second port to a second syringe which is previously loaded with a fixative composition;
(c.iv) discharging said fixative composition from said second syringe through said filter chamber assembly, said fixative composition thereby suspending the material of the solid part of the sample and flushing it back from said filter through said first port; and
(c.v) placing an aliquot of the suspended material from the solid part of the concentrated sample in the fixative composition exited through said first port onto a hot glass slide.

One of the inventive products included in the invention is the cell preservative composition used in the claimed process. In an embodiment of the cell preservative composition it comprises:
between 15 and 65% (v/v) of an alcohol;
between 5 and 15% (v/v) of a buffer solution containing salts of sodium monobasic and dibasic phosphates, sodium chloride and potassium chloride;
between 10 and 25% (v/v) of an anti-clumping solution;
between 1 and 5% (v/v) of a surfactant solution;
between 1 and 5% (v/v) of glycerine;
between 15 and 50% (v/v) of ozonized mineral water; and
between 0.025 and 0.040% (v/v) of HCl to adjust the pH between 6.65 and 7.00.

In a preferred embodiment, the anti-clumping solution of the cell preservative composition is 0.4% disodium EDTA in ozonized mineral water.

In another preferred embodiment and considered a novel aspect of the invention is the inclusion of a surfactant solution in the cell preservative composition comprising coconut soap as provided by TSECSO, S.A., Costa Rica, in ozonized mineral water.

Another of the inventive products used in the claimed method is a fixative composition which comprises:
between 40 and 60% (v/v) of glacial acetic acid;
between 20 and 60% (v/v) of a mixture of alcohols;
between 2 and 5% (v/v) of an anti-clumping agent;
between 0.05 and 0.15% (v/v) of a surfactant solution;
between 0.05 and 0.15% (v/v) of acetylcysteine;
between 0.05 and 0.15% (v/v) of lysine;
between 0.05 and 0.15% (v/v) of glycerol; and
between 10 and 20% (v/v) of ozonized mineralized water.

In a preferred embodiment, the alcohols mixture included in the fixative composition comprises ethanol, isopropyl alcohol and methanol in a relation of 2:1:1 respectively.

In this fixative compositions are also present in preferred embodiments an anti-clumping solution such as 0.4% disodium EDTA in ozonized mineral water and a surfactant solution comprising coconut soap as provided by TSECSO, S.A., Costa Rica, in ozonized mineral water.

Another inventive composition used in the inventive method is an improved transparent thermoplastic polymer-based solidifying mounting medium for the examination of the sample on a glass slide, which comprises:
between 10 and 25% (v/v) of cellulose acetate butyrate;
between 5 and 15% (v/v) of isopropanol;
between 5 and 15% (v/v) of butanol;
between 20 and 30% (v/v) of toluene;
between 30 and 40% (v/v) of xylene; and
between 10 and 20% (v/v) of propylene glycol.

Besides providing the advantage of not requiring a slide cover slip, this mounting medium provides optimal optical performance thanks to an adequate combination of solvents. Another advantage is that it enables the usage of staining solutions which are exempt of xylene.

When the step of processing the sample takes place in a filter chamber assembly, an alternative embodiment involves adding phytohemaglutinin to the sample in the first syringe pump. This improves the ability eliminate blood cells which are not of interest for cytological purposes.

The invention also includes a filter chamber assembly for processing the samples in the claimed method. The device comprises:
(i) a main cylindrical chamber body with conical ends, said conical ends extending outwardly along the axis of said cylindrical body, a first port at the vertex of one of said conical ends and a second port at the vertex of the opposite conical ends
(j) a circular membrane filter installed inside said cylindrical chamber body, near the middle of said cylindrical body in a position perpendicular to the axis of said body, the edges of said filter attached to the internal walls of said cylindrical body, such that a fluid entering either of said ports may only reach the opposite port by flowing through said filter.

In a preferred embodiment of the inventive device, the diameter of said main cylindrical chamber body is greater than its length.

In another preferred embodiment of the inventive device, at least one of said ports of the filter chamber assembly mates the port of an existing syringe pump to produce a fluid-conveying connection.

The membrane filter in said filter chamber assembly is preferably made from either nitrocellulose or nylon.

In a preferred embodiment the filter in said filter chamber assembly is also coated with phytohemaglutinin.

In the inventive filter chamber assembly, the inside wall of at least the conical end corresponding to said first port contains at least one groove, said groove with a substantially semi-cylindrical cross-section and extending along an sinuous path beginning near the base of said conical end wall and ending near the edge between said conical end and said port, said semi-cylindrical cross-section being relatively wider at the beginning of said path and progressively narrower towards the end of said path.

The invention also provides a diagnostic kit for preparing specimens for cytology microscopic examination, which comprises:
at least one sample collector device with a detachable portion sterilely packaged;
between 15 and 65% (v/v) of an alcohol;
between 5 and 15% (v/v) of a buffer solution containing salts of sodium monobasic and dibasic phosphates, sodium chloride and potassium chloride;
between 10 and 25% (v/v) of an anti-clumping solution;
between 1 and 5% (v/v) of a surfactant solution;
between 1 and 5% (v/v) of glycerine;
between 15 and 50% (v/v) of ozonized mineral water; and
between 0.025 and 0.040% (v/v) of HCl to adjust the pH between 6.65 and 7.00;
at least one second vial containing a fixative composition which comprises:
between 40 and 60% (v/v) of glacial acetic acid;
between 20 and 60% (v/v) of a mixture of alcohols;
between 2 and 5% (v/v) of an anti-clumping agent;
between 0.05 and 0.15% (v/v) of a surfactant solution;
between 0.05 and 0.15% (v/v) of acetylcysteine;
between 0.05 and 0.15% (v/v) of lysine;
between 0.05 and 0.15% (v/v) of glycerol; and
between 10 and 20% (v/v) of ozonized mineralized water;
at least one third vial containing a transparent thermoplastic polymer-based solidifying mounting medium which comprises:
a) between 10 and 25% (v/v) of cellulose acetate butyrate;
b) between 5 and 15% (v/v) of isopropanol;
c) between 5 and 15% (v/v) of butanol;
d) between 20 and 30% (v/v) of toluene;
e) between 30 and 40% (v/v) of xylene; and
f) between 10 and 20% (v/v) of propylene glycol;
at least one fourth set of one or more vials containing staining solutions exempt of xylene, and
   optionally at least one filter chamber assembly for processing the samples.

In a preferred embodiment of the inventive diagnostic kit, the anti-clumping solution of the cell preservative composition is 0.4% disodium EDTA in ozonized mineral water.

In another preferred embodiment of the inventive diagnostic kit, the surfactant solution of the cell preservative composition is coconut soap as provided by TSECSO, S.A., Costa Rica, in ozonized mineral water.

In another preferred embodiment of the inventive diagnostic kit, the alcohols mixture of the fixative composition comprises ethanol, isopropyl alcohol and methanol in a relation of 2:1:1 respectively.

In another preferred embodiment of the inventive diagnostic kit, the anti-clumping solution of the fixative composition is 0.4% disodium EDTA in ozonized mineral water.

In another preferred embodiment of the inventive diagnostic kit, the surfactant solution of the fixative composition is coconut soap at as provided by TSECSO, S.A., Costa Rica, in ozonized mineral water.

The present invention will be disclosed more particularly in the following detailed description and working examples, which intend to illustrate the invention but not in any way to limit its scope.

### BRIEF DESCRIPTION OF THE DRAWINGS

FIG. 1 is a schematic side view of a filter chamber assembly connected to a first syringe pump according to the present invention, showing the step in which a cytological sample is pumped through the filter, part of the sample being retained in the filter and the rest being discarded

FIG. 2 is a schematic side view of a filter chamber assembly connected to a second syringe pump according to the present invention, showing the step in which a fixative composition is pumped through the filter, back-flushing a sample out of the filter chamber assembly and laying an aliquot on a glass slide.

FIG. 3 is a schematic side view of a filter chamber assembly according to the present invention, showing the location of sinuous grooves inside the chamber.

FIG. 4 is a schematic detail view of two sinuous grooves in the filter chamber assembly, showing also the cross-section of the grooves.

### DETAILED DESCRIPTION OF THE INVENTION

The present invention provides inventive methods and products suitable for liquid-based cytology, characterized by being simple, reliable and inexpensive in comparison to the prior art, while providing a new type of cleaning and of assembly of the biological material on a slide in much less type than the previous art.

The inventive method for preparing a specimen from a tissue sample for cytology microscopic examination has been created together with several compositions and a device for expedite processing. By combining theses improved compositions and device, this simplified method is able to produce high quality results in the cytological analysis of the samples.

The invention has been developed as an alternative screening test for early detection of precancerous lesions of uterine cervical cancer. It is a test in the same cost range as the traditional Pap smear (even lower if time and labor are taken into account) but with all the technical and scientific improvements of liquid-based cytology. In several studies carried out with this test it is shown that the system detects more lesions than the traditional Pap technique.

In these studies, the diagnoses of a total of 58,297 Pap smears were compared. Of this total 31,601 were smear (cytology) and 26,696 were carried out with the method and compositions of the present invention. The studies were evaluated by cyto technologists and pathologists. The results showed that liquid-based cytology of the invention, increased diagnostics for low-grade intraepithelial lesions (LSIL) in 56 and by 8.73%, for high-grade intraepithelial lesions (HSIL), respectively, decreases inflammatory diagnoses increased by 31.3% and negative diagnoses for malignant cells in 34.6%.

Liquid-based cytology of the present invention is used as a Pap smear. However, it uses a different anatomical collection device with removable portion, resulting from the combination of plastic spatula and endocervical brush. Unlike conventional cytology, which is performed by immediately applying the sample on the slide, in this method an evolved brush end is inserted into a fixing solution in which the cells are preserved and disperses the cells. At this stage the cleaning process of the sample also begins. Once in the laboratory, the sample (cells) is selectively collected and concentrated by filtering or by centrifugation, and then transferred to the slide, on which staining, mounting and diagnostics proceed. Since the sample is preserved and fixed immediately after collection and the process removes material that may interfere the evaluation of epithelial cells such as blood, mucus and inflammatory cells, the results is that there are fewer artifacts in cell morphology. Furthermore the cells are deposited in a single layer, like a mosaic, which facilitates the cell observation (Agency for Health Care Policy and Research, Rockville. Evaluation of cervical cytology. Summary, Evidence Report/Technology Assessment: January 1999. Nr 5 and McGoogan E. Liquid-based cytology: the new screening test for cervical cancer control. Journal of Family Planning and Reproductive Health Care 2004; 30: 123-125).

Among the advantages that have been obtained with this method based on liquid cytology, is the reduction of inadequate samples, according to a study (18, 19) it reduces the area of inadequate quality from 9 to 1-2% and decreases the time spent in results interpretation, because it facilitates the observation of cells (18). The specificity of conventional cytology is 0.98 (95% confidence interval) and the sensitivity is 0.51 (95% confidence interval).

The following examples will explain how to prepare and/or uses these compositions in the invention.

### Example 1

### Processing the Samples for Cervical Screening, using the Inventive Method, Compositions and Device

For carrying out the method of the present invention, as used for the particular purpose of cervical screening, the following main steps are followed:
(a) Collecting a tissue sample from a subject using an appropriate collector device with a detachable portion. A preferred collector for cervical screening is a cervical brush with a special anatomical structure, readily available in the market, which incorporates a central brush tip with endocervical curettage and a collection of lateral bristles at the sides. This brush is inserted into the cervix and rotated for 5 laps clockwise. In this way and in a single operation an adequate sample is retrieved, with the effective retrieval of the 2 types of cervical cells for cytologic examination. It is worth noting for the purpose of subsequent steps that when these types of samples are taken the patient produces a significant amount of endocervical mucus, a phenomenon that hinders the vision and reduces the quality of the cytologic sample.
(b) Preserving the sample. In this step the tip of the cervical brush is detached and placed in a vial containing a cell preservative with a special innovative composition, which will be described further ahead;
(c) Processing the sample. The purpose of this step is to treat the samble with a special fixative composition which will be described further ahead, and to place an aliquot of this sample on glass slide. This step may proceed using a method selected from the group consisting of processing in a test tube and processing in a filter chamber assembly 1. The detailed sub-steps for these methods will be described further ahead.
(d) As a completion of the two alternative methods for the previous step, the processed sample is allowed the to dry on the glass slide until the cytological material is adhered to said glass slide;
(e) A staining procedure. In a preferred embodiment this step proceeds as follows: wash the slide in water (10 dips); wash again (10 dips); dip in an acid alcohol solution (500 ml of alcohol with 10 drops of 37% hydrochloric acid); wash in water (10 dips); dip in aqua ammonia (500 ml of water with 10 drops of ammonia); wash in 95° alcohol (10 dips); wash again in 95° alcohol (10 dips); dip in hematoxylin for two minutes; wash in 95% alcohol (10 dips); wash again in 95% alcohol (10 dips); dip in Orange OG-6 staining for 2 minutes; wash in 95° alcohol (10 dips); wash again in 95° alcohol (10 dips); dip in EA-50 staining solution for 30 seconds; wash in 95° alcohol (10 dips); wash again in 95° alcohol (10 dips).
(f) Allow the stained sample to dry by evaporation. It is worth noting that, as opposed to the previous art, no xylene is used in this and the previous step. Xylene is known to be hazardous for human health. Therefore avoiding its used during the staining procedure is an important advantage.
(g) A solidifying mounting medium is added to the sample. The method of present invention relies on an improved transparent thermoplastic polymer-based solidifying mounting medium, which will be described in detail further ahead. In a preferred embodiment, 0.2 ml of said mounting medium is added on the stained cytological slide.
(h) The specimen is allowed to dry on the slide for 20 minutes at room temperature, to be ready for microscopic examination.

The step of processing the sample in a test tube generally proceeds in eight sub-steps. In a first sub-step the sample, which is already suspended in the preservative liquid as a result of a previous step, is transferred from the vial to a test tube. In a second sub-step the sample is concentrated the sample by centrifugation. In a preferred embodiment, a simple fixed-angle centrifuge is sufficient, thanks to the effectiveness of the preservative solution in cleaning the sample. In a third sub-step the supernatant material is decanted from the test tube, thereby concentrating the sample. In a fourth sub-step 5 drops of the fixative solution is added. This initiates the extraction of interfering substances. In a fifth sub-step the test tube is shaken in order achieve homogenization of the cellular material. In a sixth step water is added and the test tube is shaken again for further homogenization. In a seventh sub-step of the preferred embodiment an aliquot of 0.5 cc is extracted from the homogenized sample by introducing a collector probe at a depth of 1 cm from the surface of the liquid and collecting the biological material from the test tube. In an eight sub-step the extracted aliquot is placed on a hot glass slide which has been previously heated to 50° C. for 15 minutes in order to promote evaporation of the remaining liquid and drying the cytological material adhered to the slide.

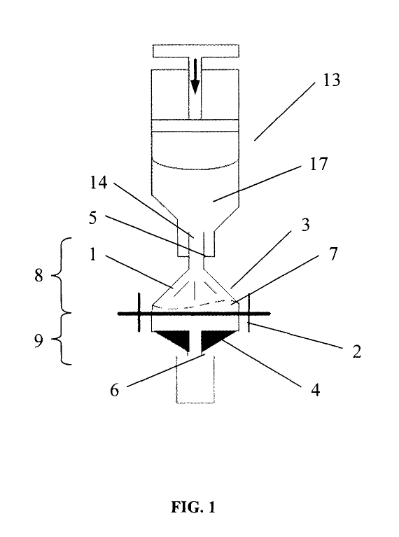

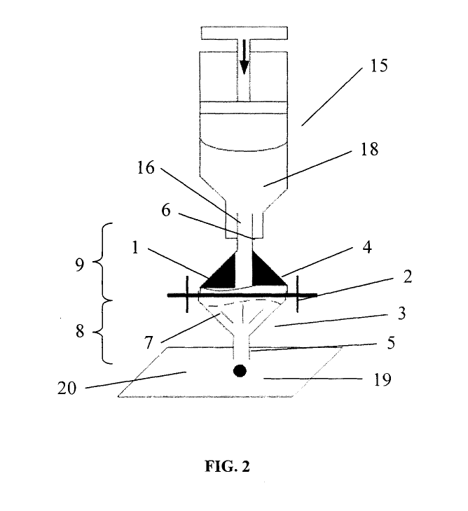

The step alternative of processing the sample in a filter chamber assembly 1, which is illustrated as an exemplary embodiment in FIG. 1 and FIG. 2, said filter chamber assembly 1 comprises a main cylindrical chamber body 2, with conical ends 3 and 4, said conical ends 3 and 4 extending outwardly along the axis of said cylindrical body 2, a first port 5 at the vertex of one conical end 3 and a second port 6 at the vertex of the opposite conical end 4. The first port 5 and the second port 6 define a fluid flow path through the chamber 1. A membrane filter 7, typically circular, is installed inside said cylindrical chamber body 2, in a position perpendicular to the axis of said cylindrical body 2, the edge of said filter 7 attached to the internal wall of said cylindrical body 2, such that a fluid following the path defined by the ports 5, 6 may only do so by flowing through said filter 7.

For manufacturing purposes, the filter chamber assembly may be made of two separate portions 8 and 9, which may be detachable so they can be easily cleaned and reused. This configuration would also allow to clean and reuse the filter 7 or to replace it with a new one. In a preferred embodiment the filter 7 seats on a recess between these portions 8, 9. However, the present invention does not exclude the possibility of these portions 8, 9 being joined permanently as a disposable device and the filter being also detachable or permanently joined to them.

In a preferred embodiment the first port 5 of the filter chamber assembly 1 mates the port 14 of an existing syringe pump 13 to produce a fluid-conveying connection. Likewise, the second port 6 of the filter chamber assembly 1 mates the port 16 of an existing syringe pump 15. This does not exclude the possibility of connecting the chamber to a syringe pump by other means or connecting it to another device. This connection would typically be of the male-female type and it may or may not include threads to secure the connection.

In a preferred embodiment the membrane filter 7 is made from nitrocellulose and nylon of from glass fiber and is coated with phytohemaglutinin.

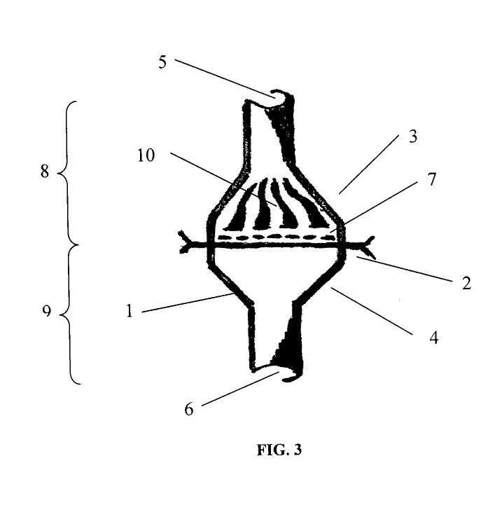

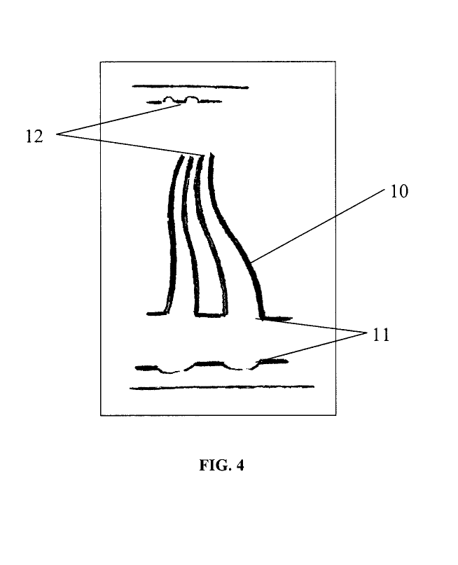

In a preferred embodiment the inside wall of the conical end 3 contains a series of grooves 10, as shown in FIG. 3. These grooves have a substantially semi-cylindrical cross-section 11, 12 and extend along a sinuous path beginning near the base of the conical end 3 wall and ending near the edge between said conical end 3 and the corresponding first port 5. As shown in FIG. 4, this semi-cylindrical cross-section 11 is relatively wider at the beginning of said path and progressively becomes a narrower section 12 towards the end of said path. In this preferred embodiment the grooves 10 start at 0.003″ in cross section 11 width and end at a cross section 12 width of 0.001″. This dimension range is similar to the size of the cells of interest in the particular case of cervical screening. This does not exclude the possibility of using different dimensions or having a chamber without grooves.

In a first sub-step of the method for processing in a filter chamber assembly, the sample suspended in the preservative composition inside the collector vial is loaded into a first syringe pump 13. This syringe pump may be operated manually or by a mechanical driver. The first syringe pump 13 is connected to the first port 5 of the filter chamber assembly 1. In a second sub-step the sample 17 is discharged from the first syringe pump 13, it then flows through the filter 7, the solid part of the sample, which includes the cells of interest for cytological purposes, being thereby retained in the filter 7, while the fluid part, including smaller solids which are not relevant, passes through said filter 7 and is discarded through the second port 6. In a third sub-step the filter chamber assembly 1 is detached from the first syringe pump and its second port 6 is connected to a second syringe pump 15, which is previously loaded with a fixative composition 18. In a fourth sup-step the fixative composition 18 is discharged from the second syringe pump 15 through the filter chamber assembly 1. As the fixative solution 18 flows through the filter 7, it collects the portion of the sample which concentrated on the surface of the filter 7 and mixes with it. This process is known as backflush. As the fixative solution 18 continues to flow with the sample suspended in it, it exits the filter chamber assembly through the first port 5. Finally in a fifth sub-step, by controlling the volume that is delivered, an aliquot 19 of approximately 0.5 cc is laid on a glass slide 20 which has been previously heated to approximately 50° C. for 15 minutes.

During the processing step in a filter chamber assembly 1 as described above the cell grooves 10 have functionality in cradling the larger cells (which include exocervical and endocervical) and in promoting their delivery to the slide 20. The cell grooves 10 are intended to cradle these larger cells as they are delivered and disrupt any adhesion to the walls of the filter chamber assembly 1. The non direct (sinusoid) pathway also has the advantage of a gentler delivery of these larger cells onto the slide. The smaller inclusions would either pass through the phytohemagluttinin pretreated filter 7, to be discarded through the second port 6, or they would be trapped within the filter 7 matrix. These components would primarily include but not be limited to blood components and fibrous material.

In an alternative embodiment, the step of processing in a filter chamber assembly 1 involves adding phytohemaglutinin to the sample in the first syringe pump 13. This improves the ability eliminate blood cells which are not of interest for cytological purposes.

In a preferred embodiment the invention is supplied as a diagnostic kit for preparing specimens for cytology microscopic examination, which comprises:
500 sample collector devices with a detachable portion;
500 vials for collecting the samples and containing the cell preservative composition
at least one vial containing the fixative composition;
at least one third vial containing the transparent thermoplastic polymer-based solidifying mounting medium;
at set of vials containing three staining solutions which are exempt of xylene, and
optionally 500 filter chamber assemblies for processing the samples.

Besides the filtering device and method described, the test is based on new and inventive compositions which allow obtaining accurate results with basic technical equipment.

### Example 2

### Preparation of the Cell Preservative Composition

The cell preservative solution is prepared using the following procedure:
(a) Preparing the buffering solution in ethanol:
i. 10.6 g of sodium dibasic phosphate are dissolved in warm deionized water in a 1 liter beaker.
ii. 100 g of sodium chloride, 2.5 g of sodium monobasic phosphate and 2.5 g of potassium chloride are added to the warm water dissolution with sodium dibasic phosphate.
iii. 200 ml of ethanol (96%) are added to the solution above solution and the mix is stirred until completely dissolved. QS with deionized water to 1 liter.
(b) A 0.4% disodium EDTA solution in ozonized mineral water is prepared.
(c) A 0.35% coconut soap solution in ozonized mineral water is prepared.
(d) Preparing 5 l of the cell preservative composition:
i. Ethanol (96%) is added to 40% of the volume. This component in the solution acts as preservative and fixative (prevent autolysis).
ii. PBS as the buffering solution comprising sodium and potassium phosphate salts, sodium chloride, water and ethanol is added at 10% of the volume.
iii. EDTA solution in ozonified mineral water is added at 14.1%. This component acts anti-clumping and cleaning agent of cell surface to improve visibility.
iv. The coconut surfactant solution in ozonified mineral water is added at 3.4%. This component acts as surfactant substance of the composition.
v. Glycerin is added at 2.1%. This component acts as anti-clumping agent too.
vi. The volume of 5 l is completed with ozonified mineral water.
vii. The final pH of the composition is adjusted to pH 6.8, using HCl.

### Example 3

### Preparation of the Fixative Composition

The fixative composition used in the present invention is prepared using the following procedure:
(a) A 0.4% disodium EDTA solution in ozonized mineral water is prepared.
(b) A 0.35% coconut soap solution in ozonized mineral water is prepared.
(c) A 4% solution of glacial acetic acid prepared in 1 L ozonized mineral water, to complete 50% of the final composition. This component acts as mucolytic agent.
(d) Acetylcysteine is added to complete 0.1% of the final composition, stirring until completely dissolved. Acetylcysteine not only acts as mucolytic agent but also helps to the extraction and separation of interfering substances.
(e) The 0.4% disodium EDTA solution previously prepared is added to add 3.3% of the final composition. In this composition the EDTA solution works as anti-clumping agent and cleans the cell surface to improve visibility.
(f) L-lysine is added at 0.1%. This component helps to the poly-cationic glass adhesion.
(g) A mixture of alcohols are added, comprising ethanol (96%) at 16.6%, isopropylic alcohol at 8.3% and methanol at 8.3% of the final concentration in the composition. These alcohols together reinforce their fixative function (prevent autolysis).
(h) Glycerol is added at 0.1% of the final composition. This multifunctional component helps acts as anti-clumping agent, contributes to the cell wall stability and helps for the extraction/separation of interfering substances.
(i) The 0.35% coconut soap solution previously prepared is added at 0.1% of the final composition. This acts as surfactant and Anti-clumping agent, and also helps in the extraction/separation of interfering substances.
(j) The volume of the composition is completed with ozonized mineral water.

### Example 4

### Preparation of the Transparent Thermoplastic Polymer-Based Solidifying Mounting Medium

For the preparation of this mounting media, a mix of various solvents is used, which is accurately calibrated to achieve optical perfection and speed up curing. ACS level grade ingredients are used for high quality and purity in order to avoid optical interference form impurities.

The components of this medium and the concentration thereof are:
cellulose acetate butyrate (transparent thermoplastic polymer) at 17.1%;
isopropanol (solvent) at 8.3%;
butanol (solvent) at 6.9%;
toluene (solvent) at 24%;
xylene (solvent) at 24%; and
propylene glycol (solvent) at 17.1%.

Said mounting medium is prepared by mixing the ingredients above, using adequate equipment and making sure no bubbles are formed.

Besides providing the advantage of not requiring a slide cover slip, this mounting medium provides optimal optical performance thanks to an adequate combination of solvents. One of the advantages of the inventive mounting medium is that enables the usage of staining solutions which are exempt of xylene.

What is claimed is:

1. A method for preparing a specimen from a tissue sample for cytology microscopic examination comprising the following main steps:
(a) collecting a tissue sample from a subject using an appropriate collector device with a detachable portion;
(b) preserving said sample in a liquid suspension by placing said detachable collector device portion inside a vial containing a cell preservative composition;
(c) processing said sample with a fixative composition in order to fix it on a hot glass slide, using a method selected from the group consisting of processing in a test tube and processing in a filter chamber assembly;
(d) allowing the processed sample to dry on the glass slide until the cytological material is adhered to said glass slide;
(e) adding a staining solution to the dried sample on the glass slide;
(f) waiting for the drying of the stained sample;
(g) adding a solidifying mounting medium to the sample; and
(h) allowing the specimen to dry on the slide to be ready for microscopic examination.

2. The method of claim 1, wherein the step of processing the sample in a test tube comprises the following sub-steps:
(c.i) transferring the sample suspended in the preservative liquid from the vial to a test tube;
(c.ii) concentrating the sample by centrifugation;
(c.iii) decanting the supernatant fluid;
(c.iv) adding a fixative composition;
(c.v) shaking the test tube to achieve homogenization of the cellular material;
(c.vi) adding water and shaking again the test tube for homogenization;
(c.vii) extracting an aliquot from the homogenized sample; and
(c.viii) placing the extracted aliquot on a hot glass slide.

3. The method of claim 1, wherein the step of processing the sample in a filter chamber assembly comprises the following sub-steps:
(c.i) loading the sample in the preservative composition into a first syringe pump
(c.ii) discharging the sample through a filter chamber assembly whose first port is connected to said first syringe pump, the solid part of the sample being thereby retained in said filter, while the fluid part passes through said filter and is discarded through a second port from said filter chamber assembly;
(c.iii) detaching said filter chamber assembly from said first syringe pump and connecting said second port to a second syringe pump which is previously loaded with a fixative composition;
(c.iv) discharging said fixative composition from said second syringe pump through said filter chamber assembly, said fixative composition thereby suspending the material of the solid part of the sample and flushing it back from said filter through said first port; and
(c.v) placing an aliquot of the suspended material from the solid part of the concentrated sample in the fixative composition exited through said first port onto a hot glass slide.

4. The method of claim 3 wherein phytohemaglutinin is added to the sample in the first syringe pump.

5. The method of claim 1 wherein the cell preservative composition comprises:
between 15 and 65% (v/v) of an alcohol;
between 5 and 15% (v/v) of a buffer solution containing salts of sodium monobasic and dibasic phosphates, sodium chloride and potassium chloride;
between 10 and 25% (v/v) of an anti-clumping solution;
between 1 and 5% (v/v) of a surfactant solution;
between 1 and 5% (v/v) of glycerine;
between 15 and 50% (v/v) of ozonized mineral water; and
between 0.025 and 0.040% (v/v) of HCl to adjust the pH between 6.65 and 7.00.

6. The method of claim 5, wherein the anti-clumping solution is 0.4% disodium EDTA in ozonized mineral water.

7. The method of claim 5, wherein the surfactant solution is 0.35% coconut soap in ozonized mineral water.

8. The method of claim 1, wherein the fixative composition comprises:
between 40 and 60% (v/v) of glacial acetic acid;
between 20 and 60% (v/v) of a mixture of alcohols;
between 2 and 5% (v/v) of an anti-clumping agent;
between 0.05 and 0.15% (v/v) of a surfactant solution;
between 0.05 and 0.15% (v/v) of acetylcysteine;
between 0.05 and 0.15% (v/v) of lysine;
between 0.05 and 0.15% (v/v) of glycerol; and
between 10 and 20% (v/v) of ozonized mineralized water.

9. The method of claim 8, wherein the alcohols mixture comprises ethanol, isopropyl alcohol and methanol in a relation of 2:1:1 respectively.

10. The method of claim 8, wherein the anti-clumping solution is 0.4% disodium EDTA in ozonized mineral water.

11. The method of claim 8, wherein the surfactant solution is 0.35% coconut soap in ozonized mineral water.

12. The method of claim 1 wherein the staining solution is exempt of xylene.

13. The method of claim 1 wherein said mounting medium is a transparent thermoplastic polymer-based solidifying mounting medium comprising:
between 10 and 25% (v/v) of cellulose acetate butyrate;
between 5 and 15% (v/v) of isopropanol;
between 5 and 15% (v/v) of butanol;
between 20 and 30% (v/v) of toluene;
between 30 and 40% (v/v) of xylene; and
between 10 and 20% (v/v) of propylene glycol.

14. The method of claim 1 wherein said filter chamber assembly comprises:
(a) a main cylindrical chamber body with conical ends, said conical ends extending outwardly along the axis of said cylindrical body, a first port at the vertex of one of said conical ends and a second port at the vertex of the opposite conical ends
(b) a membrane filter installed inside said cylindrical chamber body in a position perpendicular to the axis of said body, the edges of said filter attached to the internal walls of said cylindrical body, such that a fluid entering either of said ports may only reach the opposite port by flowing through said filter.

15. The method of claim 14 wherein the diameter of said main cylindrical chamber body is greater than its length.

16. The method of claim 14 wherein at least one of said ports of the filter chamber assembly mates the port of an existing syringe pump to produce a fluid-conveying connection.

17. The method of claim 14 wherein said membrane filter in said filter chamber assembly is made of nitrocellulose or nylon or a mesh glass fiber.

18. The method of claim 14 wherein said filter in said filter chamber assembly is coated with phytohemaglutinin.

19. The method of claim 14 wherein the inside wall of at least the conical end corresponding to said first port contains at least one groove, said groove with a substantially semi-cylindrical cross-section and extending along an sinuous path beginning near the base of said conical end wall and ending near the edge between said conical end and said port, said semi-cylindrical cross-section being relatively wider at the beginning of said path and progressively narrower towards the end of said path.

20. A cell preservative composition for preparing specimens for cytology microscopic examination which comprises:
between 15 and 65% (v/v) of an alcohol;
between 5 and 15% (v/v) of a buffer solution containing salts of sodium monobasic and dibasic phosphates, sodium chloride and potassium chloride;
between 10 and 25% (v/v) of an anti-clumping solution;
between 1 and 5% (v/v) of a surfactant solution;
between 1 and 5% (v/v) of glycerine;
between 15 and 50% (v/v) of ozonized mineral water; and
between 0.025 and 0.040% (v/v) of HCl to adjust the pH between 6.65 and 7.00.

21. The cell preservative composition of claim 20, wherein the anti-clumping solution is 0.4% disodium EDTA in ozonized mineral water.

22. The cell preservative composition of claim 20, wherein the surfactant solution is 0.35% coconut soap in ozonized mineral water.

23. A fixative composition for preparing specimens for cytology microscopic examination which comprises:
between 40 and 60% (v/v) of glacial acetic acid;
between 20 and 60% (v/v) of a mixture of alcohols;
between 2 and 5% (v/v) of an anti-clumping agent;
between 0.05 and 0.15% (v/v) of a surfactant solution;
between 0.05 and 0.15% (v/v) of acetylcysteine;
between 0.05 and 0.15% (v/v) of lysine;
between 0.05 and 0.15% (v/v) of glycerol; and
between 10 and 20% (v/v) of ozonized mineralized water.

24. The fixative composition of claim 23, wherein the alcohols mixture comprises ethanol, isopropyl alcohol and methanol in a relation of 2:1:1 respectively.

25. The fixative composition of claim 23, wherein the anti-clumping solution is 0.4% disodium EDTA in ozonized mineral water.

26. The fixative composition of claim 23, wherein the surfactant solution is 0.35% coconut soap in ozonized mineral water.

27. A transparent thermoplastic polymer-based solidifying mounting medium for preparing specimens for cytology microscopic examination which comprises:
between 10 and 25% (v/v) of cellulose acetate butyrate;
between 5 and 15% (v/v) of isopropanol;
between 5 and 15% (v/v) of butanol;
between 20 and 30% (v/v) of toluene;
between 30 and 40% (v/v) of xylene; and
between 10 and 20% (v/v) of propylene glycol.

28. A diagnostic kit for preparing specimens for cytology microscopic examination comprising:
(a) at least one sample collector device with a detachable portion;
(b) at least one first vial for collecting the samples and containing a cell preservative composition which comprises:
between 15 and 65% (v/v) of an alcohol;
between 5 and 15% (v/v) of a buffer solution containing salts of sodium monobasic and dibasic phosphates, sodium chloride and potassium chloride;
between 10 and 25% (v/v) of an anti-clumping solution;
between 1 and 5% (v/v) of a surfactant solution;
between 1 and 5% (v/v) of glycerine;
between 15 and 50% (v/v) of ozonized mineral water; and
between 0.025 and 0.040% (v/v) of HCl to adjust the pH between 6.65 and 7.00,
(c) at least one second vial containing a fixative composition which comprises:
between 40 and 60% (v/v) of glacial acetic acid;
between 20 and 60% (v/v) of a mixture of alcohols;
between 2 and 5% (v/v) of an anti-clumping agent;
between 0.05 and 0.15% (v/v) of a surfactant solution;
between 0.05 and 0.15% (v/v) of acetylcysteine;
between 0.05 and 0.15% (v/v) of lysine;
between 0.05 and 0.15% (v/v) of glycerol; and
between 10 and 20% (v/v) of ozonized mineralized water;
(d) at least one third vial containing a transparent thermoplastic polymer-based solidifying mounting medium which comprises:
between 10 and 25% (v/v) of cellulose acetate butyrate;
between 5 and 15% (v/v) of isopropanol;
between 5 and 15% (v/v) of butanol;
between 20 and 30% (v/v) of toluene;
between 30 and 40% (v/v) of xylene; and
between 10 and 20% (v/v) of propylene glycol;
(e) at least one set of one or more vials containing staining solutions exempt of xylene, and
(f) optionally at least one filter chamber assembly for processing the samples.

29. The diagnostic kit of claim 28, wherein the anti-clumping solution of the cell preservative composition is 0.4% disodium EDTA in ozonized mineral water.

30. The diagnostic kit of claim 28, wherein the surfactant solution of the cell preservative composition is 0.35% coconut soap in ozonized mineral water.

31. The diagnostic kit of claim 28, wherein the alcohols mixture of the fixative composition comprises ethanol, isopropyl alcohol and methanol in a relation of 2:1:1 respectively.

32. The diagnostic kit of claim 28, wherein the anti-clumping solution of the fixative composition is 0.4% disodium EDTA in ozonized mineral water.

33. The diagnostic kit of claim 28, wherein the surfactant solution of the fixative composition is 0.35% coconut soap in ozonized mineral water.
